(19) United States
(12) Patent Application Publication
(10) Pub. No.: US 2001/0022631 A1
(43) Pub. Date: Sep. 20, 2001

(54) Method for changing the channel of a television set, and corresponding television set

(76) Inventors: Gunter Scheffler, Munchen (DE); Markus Schu, Erding (DE); Dirk Wendel, Unterhaching (DE)

Correspondence Address: LERNER AND GREENBERG, P.A., Post Office Box 2480, Hollywood, FL, 32022-2480, US

(21) Appl. No.: 09/760,407

(22) Filed: Jan. 12, 2001

(30) Foreign Application Priority Data
Jan. 12, 2000 (DE) 100 00 961.1

(51) Int. Cl. H04N 5/268; H04N 5/50

(52) U.S. Cl. 348/731; 348/705

(57) ABSTRACT

In order to allow a channel of a television set to be changed as quickly as possible, the television set is equipped with at least two receiving devices. At least one of the receiving devices is set in advance to a specific channel that could be expected to be selected in the future. When a channel change is then initiated, by which the channel which has been set in advance is selected, the picture corresponding to the television signal received by the receiving device which has been set in advance can be immediately displayed.

### BACKGROUND OF THE INVENTION

Field of the Invention

The present invention relates to a method for changing the channel of a television set and to a corresponding television set having two receiving devices and a display device.

The increasing number of television channels which can be received and the increasing transmission of advertising has resulted in many television viewers not only receiving a television program or a television channel but also switching quickly and successively between different television channels. In order that channel selection for the television viewer is as simple as possible, a so-called “Up” key and a “Down” key are also provided, in addition to the numbered keys for direct channel selection, on the remote controls of most currently available television sets. The “Up” key allows the television viewer to switch to a next-higher channel from the currently set channel while the “Down” key allows a change to next-lower channel. The television viewer can thus switch successively between all the channels that can be received just by operating the “Up” or “Down” key.

However, when changing from one channel to another channel, the television picture corresponding to the new channel cannot be displayed correctly immediately, since a number of control actions on the new channel have to be carried out in the television set after a channel change. This relates in particular to control actions in the receiving device and in the television set deflection unit. The time required for this stabilization process depends essentially on the components or individual modules used in the respective television set.

Apart from the actual video information, a television signal contains, inter alia, horizontal and vertical synchronization information which stimulates control loops (phase locked loops, PLL) in a tuner and a color decoder in order to allow even signals which are subject to interference to be processed without any major adverse effect on the picture. A horizontal signal from which interference has been removed and a vertical signal from which interference has been removed are thus available, inter alia, at the output of the color decoder. When a channel change takes place, it takes a certain amount of time for the horizontal signal and the vertical signal to be matched to the newly received video signal. The time period becomes longer the greater the phase and frequency discrepancies between the corresponding signals on the old channel and the signals of the new channel. If, by coincidence, the signals of the new channel are in the same phase and have the same frequency as the signals of the old channel, the control loops in the television set will have already stabilized correctly. However, this is a special case that occurs only extremely rarely in practice.

The television set control loop associated with the color subcarrier must also stabilize at the new frequency and phase of the new color subcarrier when a channel change takes place and may even possibly need to be set to a new television standard if the television standard of the newly set channel differs from that of the old channel.

Finally, the time which the television set tuner requires to stabilize for a channel change must also be taken into account, since the corresponding television signal is not available in a stable manner for further processing until the tuner has stabilized on the new channel.

For the reasons described above, the screen of the television set is thus normally temporarily blanked out during a channel change until the control actions in the television set have stabilized on the new channel and, correct reception of the new channel and correct display of the corresponding television picture are thus possible. However, subjectively, this time appears to be long for many television viewers.

Apart from television sets having only one receiving device, television sets are also available having two or more receiving devices which each have a tuner and a color decoder. The two receiving devices are used to receive the television signals on different channels, with the television signals corresponding to the two channels being displayed on the screen in the form of superimposed television pictures or television pictures displayed alongside one another. These functions are known as the “picture in picture” (PIP) function or the “double window” function although these functions are not used for faster channel changing.

### SUMMARY OF THE INVENTION

It is accordingly an object of the invention to provide a method for changing the channel of a television set, and a corresponding television set which overcome the above-mentioned disadvantages of the prior art devices and methods of this general type, with which the time required for a channel change can be shortened and long screen blanked-out periods when switching from a currently set channel to a new channel can be avoided.

With the foregoing and other objects in view there is provided, in accordance with the invention, a method for changing a television channel. The method includes providing a television set having at least two receiving devices for receiving a television signal and a display device for displaying a picture corresponding to a received television signal. One of the receiving devices is set, in advance, to a specific channel expected to be selected in the future resulting in a preset receiving device. In the event of a channel change as a result of which the specific channel is selected, the picture corresponding to the television signal received by the preset receiving device that was set in advance is displayed by the display device.

According to the invention, a number of receiving devices are provided, with one of the receiving devices being set in advance to the channel which is expected to be set in the future as a consequence of the channel change. The preset channel can in this case be selected on the basis of the channel changing behavior of the television viewer as indicated in the past. In particular, it is possible to set the receiving device in advance to the next-lower channel or the next-higher channel if the previous channel change had resulted in switching to a lower or higher channel, respectively, since, from experience, the television viewer frequently switches successively through the channels which can be received.

When, subsequently, the channel which has already been set in advance is actually selected, it is possible to switch to the preset receiving device, which has already been stabilized on the new channel, so that the time required for the channel change is considerably shortened and a temporary incorrect or black display on the television screen can be avoided.

If the television viewer switches to a channel other than that which was expected and was set in advance, the receiving device which was preset to the incorrect channel can preferably be set to the actually selected channel while the currently active receiving device is still used to display the television picture of the currently set channel until the receiving device mentioned above has stabilized on the new channel. The actual switching to the new channel does not take place until this point, so that, although this procedure does not allow the time interval between pressing the appropriate channel selection key on the remote control and the display of the television picture corresponding to the new channel to be shortened, the stabilization processes taking place in the background are concealed from the television viewer and blanking out of the screen is avoided since the television program corresponding to the old channel is still temporarily displayed. However, in this case, it may be worthwhile outputting appropriate information to the television viewer, in particular overlaying an appropriate message, in order to confirm to the viewer that his channel change request has been received.

According to a further exemplary embodiment of the present invention, one of the existing receiving devices can also be used for a search, in which case the receiving device is set successively to different channels, and a television picture corresponding to the currently set channel is in each case displayed together with the main picture from the active receiving device. If the channel search indicates a channel which is of interest to the viewer, the viewer can stop the search by operating an appropriate key on the remote control and, possibly, also by an acoustic signal, can initiate a channel change to the corresponding channel, so that the television picture corresponding to this channel is then displayed as the main picture.

Either all the channels which can be received or only a specific number of channels may be used for the search process described above, in which case, in the second situation mentioned, those channels which are to be included in the search are, for example, programmed by the viewer or are determined by evaluation of an identifier transmitted with the television signal. For example, it would be possible to use only sports programs or only movies etc. for the search process.

The present invention can be used with both analog and digital television sets. The color decoders in the individual receiving devices and the switching and video processing device required for switching between the color decoders may be either in the form of separate integrated circuits, or may be on a chip in the form of a common integrated circuit.

In accordance with an added mode of the invention, there is the step of selecting the specific channel to which the preset receiving device is set in advance on a basis of channel changes carried out previously.

In accordance with an additional mode of the invention, there is the step of selecting the specific channel to which the preset receiving device is set in advance on a basis of a most recently selected channel.

In accordance with another mode of the invention, there is the step of providing each channel which can be received with a channel number, and the channel which has a next-higher channel number associated with it is used as the specific channel to which the preset receiving device is set in advance if the channel change carried out immediately prior to this resulted in a change to the channel having a higher channel number. And in that the channel which has a next-lower channel number associated with it is used for the channel to which the preset receiving device is set in advance if the channel change carried out immediately prior to this resulted in a change to the channel having a lower channel number.

In accordance with a further mode of the invention, there are the steps of:

carrying out a check to determine whether the channel selected by the channel change has been set in advance in the preset receiving device after the channel change takes place;

displaying the picture corresponding to the television signal received by the preset receiving device which has been set in advance on the display device if a result of the check is affirmative;

temporarily displaying the picture corresponding to the channel most recently set before the channel change on the display device if the result of the check is negative;

resetting the preset receiving device to an actual channel selected by the channel change; and

displaying on the display device the picture corresponding to the television signal received by the preset receiving device after it has been reset.

In accordance with a further added mode of the invention, there is the step of outputting additional information which informs a user that a desired channel change is currently being carried out while the picture corresponding to the channel which was most recently set before the channel change is being displayed.

In accordance with a further additional mode of the invention, there is the step of setting the preset receiving device successively to a group of different channels. The picture corresponding to the television signal received by the preset receiving device on a respectively set channel is displayed by the display device as a partial picture together with a main picture from another of the receiving devices which has been set to a most recently selected channel.

In accordance with another added mode of the invention, there is the step of pre-programming the group of different channels to which the preset receiving device is set successively.

In accordance with another additional mode of the invention, there is the step of providing the group of different channels to which the preset receiving device is set successively with only channels whose current television programs satisfy a specific criterion.

In accordance with further mode of the invention, there are the steps of transmitting an identifier which characterizes a television program using a television transmitter for each of the television programs and the identifier is evaluated in the television set. The identifier is used to decide if a corresponding channel is or is not added to the group of different channels used in a search.

In accordance with another feature of the invention, in the event of the channel change by which a channel which belongs to the group of different channels and is currently set in the preset receiving device is selected, the picture corresponding to the television signal received on a selected channel by the preset receiving device is displayed as the main picture by the display device.

With the foregoing and other objects in view there is further provided, in accordance with the invention, a television set containing at least two receiving devices for receiving a television signal; a display device for displaying a picture corresponding to the television signal; and a channel switching device connected to the receiving devices and to the display device. The channel switching device is configured to set, in advance and in accordance with a specific channel setting scheme, at least one of the receiving devices as a preset receiving device having a specific channel that is expected to be selected in the future. The channel switching device receives television signals from the receiving devices and is configured such that in an event of a channel change by which the specific channel is selected, the channel switching device supplies the television signal received by the preset receiving device to the display device for displaying a corresponding picture.

With the foregoing and other objects in view there is further provided, in accordance with the invention, a television set. The television set contains at least two receiving devices for receiving a television signal; a display device for displaying a picture corresponding to the television signal; and a channel setting means connected to the receiving devices. The channel setting means is configured to set, in advance and in accordance with a specific channel setting scheme, at least one of the receiving devices as a preset receiving device having a specific channel which is expected to be selected in the future. A control means is connected to the display device and to the receiving devices. The control means receives television signals from the receiving devices and is configured such that in an event of a channel change by which the specific channel is selected, the control means supplies the television signal received by the preset receiving device to the display device for displaying a corresponding picture.

Other features which are considered as characteristic for the invention are set forth in the appended claims.

Although the invention is illustrated and described herein as embodied in a method for changing the channel of a television set, and a corresponding television set, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a simplified block diagram for a television set according to the invention; and

FIG. 2 illustrates a method of operation for the television set shown in FIG. 1.

### DESCRIPTION OF THE PREFERRED EMBODIMENTS

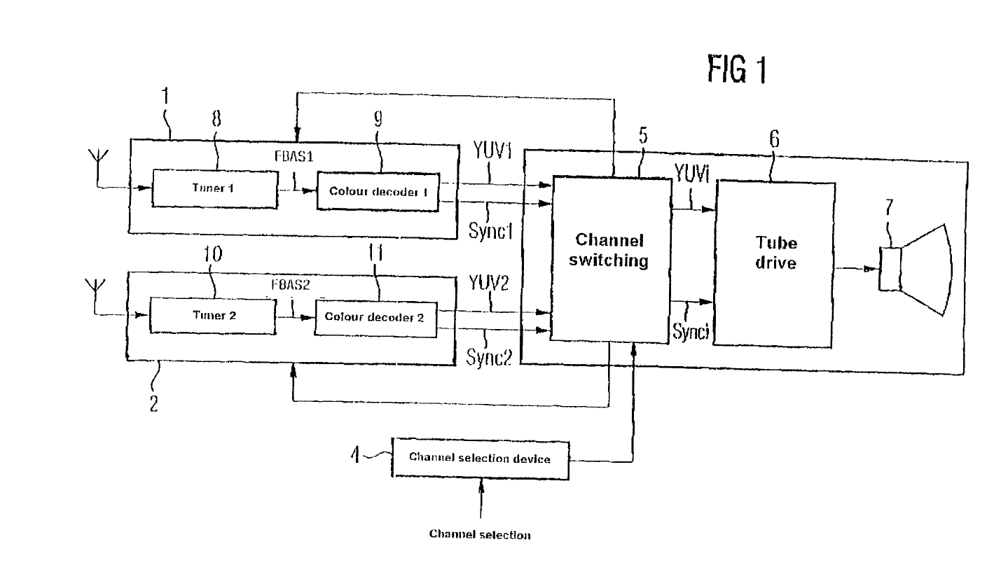

In all the figures of the drawing, sub-features and integral parts that correspond to one another bear the same reference symbol in each case. Referring now to the figures of the drawing in detail and first, particularly, to FIG. 1 thereof, there is shown a television set which contains two receiving devices 1, 2, which each have a tuner 8 or 10, respectively, and a color decoder 9 or 11, respectively. The appropriate television signal FBAS1 or FBAS2 for a specific selected channel is in each case received by the tuners 8, 10 via a receiving antenna, and is supplied to the respective color decoder 9 or 11. In addition to the actual video information, each television signal also contains, inter alia, horizontal and vertical synchronization information. Each of the color decoders 9 or 11 thus outputs a video signal YUV1 or YUV2, respectively, and synchronization information Sync1 or Sync2, respectively, with a horizontal signal from which interference has been removed, and a vertical signal from which interference has been removed. The signals are supplied to a channel switching device 5, which also carries out video processing functions for a display device 6, 7.

The switching device 5 supplies one of these video and synchronization signals to a tube drive 6 which drives the tube 7 of the television set appropriately as a function of these signals in order to display a television picture corresponding to the respective television signal, and in which case the switching device 5 can determine for each individual pixel which television signal from which receiving device 1, 2 is intended to be used for that respective pixel. This is feasible in particular in digital television sets that can use a frame memory to synchronize the signals.

The switching device 5 uses an I²C interface, for example, to communicate with a channel selection device 4, which receives a channel selection entered by the viewer, for example, via a remote control, and passes an appropriate signal to the switching device 5, which then initiates the desired channel change.

In order to explain the method of operation of the television set shown in FIG. 1, the following text assumes that the receiving device 1 is currently active and is set to a channel desired by the television viewer. The switching device 5 thus ensures that the video information supplied from the receiving device 1 is displayed on the tube or screen 7 of the television set.

Furthermore, however, the switching device 5 also ensures that the second receiving device 2 is set (although this cannot be seen by the viewer) to a channel to which it can be expected that the viewer will switch in the future. If the viewer now actually switches to this channel that is expected by the switching device 5, the switching between displaying the television picture on the old channel and the television picture on the new channel can be carried out immediately, since the required stabilization processes in the receiving device 2 have already taken place in the background. Therefore, there is no need to blank out the screen 7 or to temporarily display the television picture corresponding to the new channel incorrectly.

If, on the other hand, the viewer switches to a channel other than that which was expected and had already been preset in the receiving device 2, either the receiving device 1 or the receiving device 2 must stabilize on the new channel, as in conventional systems.

However, it is advantageous in this case for the switching device 5 to ensure that the signals supplied from the receiving device 1 continue to be used temporarily to display an appropriate television picture until the receiving device 2 has stabilized on the new channel, so that the television program on the old channel is still displayed to the viewer until a stable and correct television picture on the new channel can be displayed by the receiving device 2. The system does not switch to the receiving device 2 until this point, as a result of which a television picture corresponding to the television signal FBAS2 is displayed on the screen 7.

Although this procedure does not shorten the time interval between the viewer entering the channel change request and the actual display of the television picture corresponding to the new channel on the screen 7, in comparison with conventional television sets, the stabilization processes required for the channel change remain concealed from the viewer, however, since temporarily he can still see the television program corresponding to the old channel. In this case, it may be worthwhile for the switching device 5 to carry out suitable video processing to provide an appropriate message (“On Screen Display”, (OSD)) until the television picture is actually switched to the new channel, since, otherwise the viewer could think that his switching request had not been received by the television set so that he might press the appropriate key on his remote control several times.

During the process described above, of presetting the receiving device 1, 2 which is currently not required to a channel which it is expected will be required in the future, it is assumed that the viewer will watch the currently selected channel at least until the stabilization processes in the preset receiving device have been completed. If this is not the case, the procedure whenever a new channel change is made must be the same as that which has been described above on the basis of a channel change to a channel which was not expected and was thus not preset.

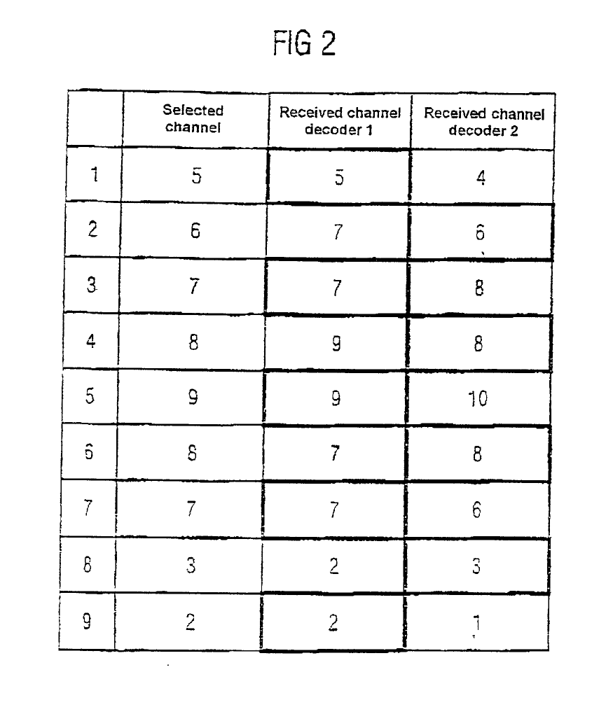

The method of operation described above will be described in more detail in the following text with reference to the illustration shown in FIG. 2, which shows, for each of nine successive channel settings or channel changes, the channel to which the receiving device 1 is set, and the channel to which the receiving device 2 is set.

First, it is assumed that the viewer has selected the channel with the channel number 5. The switching device 5 thus causes the receiving device 1 to be set to this channel while the receiving device 2 is set to any other channel, for example channel No. 4 which it is expected could be selected in the future by the viewer.

On the next channel change, the viewer selects channel No. 6. Since this channel has not been preset in the receiving device 2, channel No. 5 from the receiving device 1 is initially still displayed temporarily until the receiving device 2 has stabilized on the new channel No. 6. The television picture is then switched to channel No. 6 from the receiving device 2, and the receiving device 1 is preset to a channel expected in the future, in the present case channel No. 7.

The preset channel is preferably selected on the basis of the channel changing behavior of the viewer as indicated by past viewer selections. For example, it is possible after a channel change to a lower or higher channel for the receiving device which is currently not required to then be preset to the next-lower or next-higher channel, since the viewer frequently switches successively through the individual channels which can be received.

In the example shown in FIG. 2, the channel is then changed to channel No. 7. Since this channel has already been preset in the receiving device 1, a fast channel change and fast switching of the corresponding television picture can be carried out. The receiving device 2 is then preset to channel No. 8 in accordance with the plan described above.

Fast television picture switching to channel No. 8 is also possible when the next channel change is made, since the receiving device 2 has already been preset to this channel. The receiving device 1 is preset to channel No. 9.

The subsequent channel change results in the viewer selecting channel No. 9 that has already been set in the receiving device 1 so that a fast channel change can also be carried out in this case. The receiving device 2 is then preset to channel No. 10.

However, channel No. 8 is selected on the next channel change, and this was not preset in the receiving device 2. Channel No. 9 from the receiving device 1 is thus initially still displayed temporarily until the receiving device 2 has stabilized on the new channel No. 8. The television picture is then switched to channel No. 8 from the receiving device 2, and the receiving device 1 is preset to the next expected channel No. 7.

The next channel change to channel No. 7 confirms the supposition of the switching device 5 and a fast channel change can be carried out since channel No. 7 has already been preset in the receiving device 1. The receiving device 2 is then set in advance to channel No. 6.

However, channel No. 3 is selected on the next channel change, and this had not been preset in the receiving device 2. Channel No. 7 from the receiving device 1 is thus initially still displayed temporarily until the receiving device 2 has stabilized on the new channel No. 3. The television picture is then switched to channel No. 3 from receiving device 2, and the receiving device 1 is preset to the next expected channel No. 2.

The next channel change, to channel No. 2, once again confirms the supposition of the switching device 5, and a fast channel change can be carried out since channel No. 2 has already been preset in the receiving device 1. The receiving device 2 is then preset to channel No. 1.

FIG. 2 shows the respective active receiving device for the television picture display and the respective corresponding active decoder with thick outlines.

The present invention can be used with both analog and digital television sets so that, instead of the color decoders 9, 11 shown in FIG. 1, a configuration for digital television transmission is also conceivable, in which case, for example, a channel decoder which is adequate for the transmission path and an MPEG decoder are required for each channel. Furthermore, it is also known that the possibility of decoding two channels with only one MPEG decoder is already being considered. The present invention can, of course, also be used with systems such as this. Furthermore, it should be mentioned that the above statements do not just apply to the video information in the television signal but also to the audio information. Therefore, the receiving device 1 or 2 which has been set in advance receives both the video information and audio information from the preset channel so that, when the display device 3 is switched to this receiving device, a corresponding picture for this channel with an appropriate audio output can then be produced.

In practice, it has been found that the process described above, of presetting the receiving devices 1 and 2 to an expected channel makes it possible to save at least 80% of the time required for a channel change with conventional television sets. The time required for a channel change can be reduced overall to zero by a so-called free-running mode with conventional components that are available as the tube drive 6.

A further exemplary embodiment of the present invention will be explained in the following text.

For example, it is feasible for the television picture corresponding to a specific channel to be displayed via one receiving device, for example, the receiving device 1 shown in FIG. 1. Another receiving device, for example, the receiving device 2 shown in FIG. 1, is used to carry out a search controlled by the switching device 5, during which a number of channels are selected successively in the receiving device 2 and the television picture corresponding to the respective currently set channel is displayed on the screen 7 in the form of a small picture (“picture in picture”, (PIP)) or “split screen”, in addition to the main picture from the receiving device 1.

If, during the search, the receiving device 2 produces a channel which is of interest to the viewer, the viewer can stop the search by pressing an appropriate key on his remote control or else, for example, by an acoustic signal (for example by voice identification), and can use a further action to instruct the switching device 5 to display as the main picture on the screen 7 the television picture corresponding to the channel currently set in the receiving device 2. Then, if the viewer wishes, a search can be carried out in an analogous manner using the receiving device 1.

The search process described above may cover all the available channels. However, it is also feasible for the viewer to program, and thus to preset, those channels which are to be used for the search.

In this context, it is also feasible for the appropriate television transmitter to transmit an identifier in the form of an additional signal with every television program, with the identifier characterizing the respective television program in a specific manner. The switching device 5 then carries out the search using only those channels whose identifiers match a specific criterion. In this way, the search can use only channels whose identifiers indicate that the television program currently on them is, for example, a sports program or movie, etc., if the viewer wishes to see only sports programs or movies.

We claim:

1. A method for changing a television channel, which comprises the steps of:
providing a television set having at least two receiving devices for receiving a television signal and a display device for displaying a picture corresponding to a received television signal; and
setting one of the receiving devices, in advance, to a specific channel expected to be selected in the future resulting in a preset receiving device, and in an event of a channel change as a result of which the specific channel is selected, the picture corresponding to the television signal received by the preset receiving device which was set in advance is displayed by the display device.

2. The method according to claim 1, which comprises selecting the specific channel to which the preset receiving device is set in advance on a basis of channel changes carried out previously.

3. The method according to claim 1, which comprises selecting the specific channel to which the preset receiving device is set in advance on a basis of a most recently selected channel.

4. The method according to claim 1, which comprises providing each channel which can be received with a channel number, and the channel which has a next-higher channel number associated with it is used as the specific channel to which the preset receiving device is set in advance if the channel change carried out immediately prior to this resulted in a change to the channel having a higher channel number, and
in that the channel which has a next-lower channel number associated with it is used for the channel to which the preset receiving device is set in advance if the channel change carried out immediately prior to this resulted in a change to the channel having a lower channel number.

5. The method according to claim 1, which comprises:
carrying out a check to determine whether the channel selected by the channel change has been set in advance in the preset receiving device after the channel change takes place;
displaying the picture corresponding to the television signal received by the preset receiving device which has been set in advance on the display device if a result of the check is affirmative;
temporarily displaying the picture corresponding to the channel most recently set before the channel change on the display device if the result of the check is negative;
resetting the preset receiving device to an actual channel selected by the channel change; and
displaying on the display device the picture corresponding to the television signal received by the preset receiving device after it has been reset.

6. The method according to claim 5, which comprises outputting additional information which informs a user that a desired channel change is currently being carried out while the picture corresponding to the channel which was most recently set before the channel change is being displayed.

7. The method according to claim 1, which comprises setting the preset receiving device successively to a group of different channels, and the picture corresponding to the television signal received by the preset receiving device on a respectively set channel is displayed by the display device as a partial picture together with a main picture from another of the receiving devices which has been set to a most recently selected channel.

8. The method according to claim 7, which comprises preprogramming the group of different channels to which the preset receiving device is set successively.

9. The method according to claim 7, which comprises providing the group of different channels to which the preset receiving device is set successively with only channels whose current television programs satisfy a specific criterion.

10. The method according to claim 9, which comprises:
transmitting an identifier which characterizes a television program using a television transmitter for each of the television programs and the identifier is evaluated in the television set; and
using the identifier to decide if a corresponding channel is or is not added to the group of different channels used in a search.

11. The method according to claim 7, wherein in an event of the channel change by which a channel which belongs to the group of different channels and is currently set in the preset receiving device is selected, the picture corresponding to the television signal received on a selected channel by the preset receiving device is displayed as the main picture by the display device.

12. A television set, comprising:
at least two receiving devices for receiving a television signal;
a display device for displaying a picture corresponding to the television signal; and
a channel switching device connected to said receiving devices and to said display device, said channel switching device configured to set, in advance and in accordance with a specific channel setting scheme, at least one of said receiving devices as a preset receiving device having a specific channel which is expected to be selected in the future, said channel switching device receiving television signals from said receiving devices and is configured such that in an event of a channel change by which the specific channel is selected, said channel switching device supplying the television signal received by said preset receiving device to said display device for displaying a corresponding picture.

13. The television set according to claim 12, wherein said channel switching device selects the specific channel to which said preset receiving device is set in advance on a basis of channel changes carried out previously.

14. The television set according to claim 12, wherein said channel switching device selects the specific channel to which said preset receiving device is set in advance on a basis of a most recently selected channel.

15. The television set according to claim 12, wherein said channel switching device provides each channel which can be received with a channel number, and the channel which has a next-higher channel number associated with it is used as the specific channel to which said preset receiving device is set in advance if the channel change carried out immediately prior to this resulted in a change to the channel having a higher channel number, and in that the channel which has a next-lower channel number associated with it is used for the channel to which said preset receiving device is set in advance if the channel change carried out immediately prior to this resulted in a change to the channel having a lower channel number.

16. The television set according to claim 12, wherein said channel switching device:
carries out a check to determine whether the channel selected by the channel change has been set in advance in said preset receiving device after a channel change takes place;
displays the picture corresponding to the television signal received by said preset receiving device which has been set in advance on said display device if a result of the check is affirmative; and
temporarily displays the picture corresponding to the channel most recently set before the channel change on said display device if the result of the check is negative;
resets said preset receiving device to an actual channel selected by the channel change; and
displays on said display device the picture corresponding to the television signal received by said preset receiving device after it has been reset.

17. The television set according to claim 12, wherein said channel switching device outputs additional information which informs a user that a desired channel change is currently being carried out while the picture corresponding to the channel which was most recently set before the channel change is being displayed.

18. The television set according to claim 12, wherein:
said channel switching device transmits an identifier which characterizes a television program using a television transmitter for selected television programs and the identifier is evaluated in the television set; and
said channel switching devices uses the identifier to decide if a corresponding channel is or is not added to a group of channels used in a search.

19. The television set according to claim 18, wherein in an event of the channel change by which a channel which belongs to the group of channels and is currently set in said preset receiving device is selected, the picture corresponding to the television signal received by said preset receiving device is displayed as a main picture on said display device.

20. A television set, comprising:
at least two receiving devices for receiving a television signal;
a display device for displaying a picture corresponding to the television signal;
a channel setting means connected to said receiving devices, said channel setting means configured to set, in advance and in accordance with a specific channel setting scheme, at least one of said receiving devices as a preset receiving device having a specific channel which is expected to be selected in the future; and
a control means connected to said display device and to said receiving devices, said control means receiving television signals from said receiving devices and is configured such that in an event of a channel change by which the specific channel is selected, said control means supplying the television signal received by said preset receiving device to said display device for displaying a corresponding picture.
